(19) United States
(12) Patent Application Publication
(10) Pub. No.: US 2024/0416833 A1
(43) Pub. Date: Dec. 19, 2024

(54) SAFETY DEVICE DEPLOYMENT APPARATUS

(71) Applicant: BUS SAFETY INC., Mocksville, NC (US)

(72) Inventors: Robert Geyer, Bermuda Run, NC (US); Richard Pater, Lexington, NC (US); Scott Culbertson, Clemmons, NC (US); David Jennings, Pfafftown, NC (US); Scott Geyer, Mocksville, NC (US)

(21) Appl. No.: 18/741,885

(22) Filed: Jun. 13, 2024

Related U.S. Application Data
(60) Provisional application No. 63/472,713, filed on Jun. 13, 2023.

(51) Int. Cl. B60Q 1/50; B60Q 1/00; B60Q 1/26

(52) U.S. Cl. CPC B60Q 1/547; B60Q 1/0088; B60Q 1/2692

(57) ABSTRACT

A safety device deployment apparatus includes a housing, a hinge plate pivotally affixed to the housing to pivot around a pin, an actuator linkage assembly having an actuator including a piston, and a crankshaft affixed to the piston through at least a revolute joint and affixed to one of the pin, the hinge plate, and the safety device. The safety device deployment apparatus moves a safety device between a stowed parallel and deployed perpendicular position, relative to the housing, based on extension and retraction of the piston of the actuator. The revolute joint between the piston and crankshaft is disposed in planes on opposite sides of a parallel plane passing through the pin joint based on the extension and retraction of the piston.

### CROSS-REFERENCE TO RELATED APPLICATIONS

This application claims priority to U.S. Provisional Patent Application No. 63/472,713, which was filed on Jun. 13, 2023, the entire contents of which is hereby incorporated by reference in its entirety.

### TECHNICAL FIELD

The present disclosure relates to the field of deployment apparatuses for safety devices, such as stop signs and crossing arms, affixed to vehicles, such as school buses, generally and, in particular, apparatuses comprising an actuator linkage assembly having connecting rod and a crankshaft affixed together through a revolute joint to facilitate pivotal movement of a safety device attached to the crankshaft between a parallel position and a perpendicular position relative to a portion of the housing.

### BACKGROUND

It has become commonplace for certain vehicles, particularly buses, to include selectively deployable safety devices used to help notify and protect those around the vehicle. For example, stop sign assemblies are commonly used to provide notification to drivers around a bus that the bus is stopping and, for school buses specifically, that drivers in the area are required to stop. Generally, stop sign assemblies may include an actuator, a “stop” sign (or arm), mechanical components, and a housing. The actuator and the mechanical components are generally housed within the housing and the housing is mounted to a bus. To facilitate the motion of a stop sign, mechanical components commonly connect the actuator to the stop sign such that the stop sign moves between stowed and deployed positions as the actuator is operated. Generally, a stop sign is in a stowed position when it is mostly parallel with the bus and is utilized when a sign is not in use. The stop sign is in the deployed position when it extends out and generally perpendicular away from the bus in use to signal nearby vehicles and pedestrians that the bus is about to stop.

Moreover, crossing guard arm assemblies are also commonly utilized on the front of buses to deter people from entering the blind spot of a bus. A crossing arm assembly is similar to a stop sign assembly but normally includes a crossing guard arm having a predetermined length in place of a stop sign. When deployed, the crossing guard arm generally extends out in front of the school bus to be a physical barrier causing people using the bus to have to walk out far enough in front of the bus for the bus driver to be able to view them.

These deployable safety devices provide signals or information to others in the vicinity about the vehicle's purpose, plans, or a required act from others in the vicinity in relation to the vehicle. Indeed, federal regulations require certain deployable safety devices that can be extended outward from the side of certain vehicles, like a school bus, to provide a signal to other motorists not to pass the bus when it has stopped to load or discharge passengers. Traditionally, these federally required devices have comprised a stop sign hinged to and pivoted out from the side of the bus.

However, it is common for these assemblies to be heavy with many of the components made of metal or other durable materials. Further, it is common for these assemblies to also be difficult to install, often requiring customized installation procedures. Moreover, it is common for these assemblies to commonly wear out and/or fail due to the weight and motion of the components. Also, it is common for these assemblies to be difficult to maintain and to not have easily replaceable components. Additionally, it is common for these assemblies to also be costly to manufacture due to the nature of the components and many of the additional features desired, such as lights. Accordingly, there remains an unmet need to provide a safety device deployment apparatus which utilizes an improved design and mechanical components to translate actuator motion into movement of the safety device that overcomes some or all of these aforementioned issues.

### BRIEF SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

An object of the present disclosure is to present a safety device deployment apparatus that, in various aspects, weighs less, is easier to install, provides enhanced durability, is easier to maintain, has easily replaceable components, and costs less to manufacture.

In various embodiments, a safety device deployment apparatus comprises a housing defining an aperture, a hinge plate affixed to a safety device, wherein the hinge plate is pivotally connected to the housing through a connection with a pin extending through the aperture. In embodiments, the apparatus also includes an actuator linkage assembly comprising an actuator attached to a portion of the housing and configured to move a piston linearly between a retracted position and extended position, and a crankshaft having at least a first revolute joint affixing a first portion of the crankshaft to the piston and a second portion affixed to one of the pin, the hinge plate, and the safety device. In embodiments, movement of a distal end of the piston between an extended and retracted position, relative to the center of the actuator, pivots the hinge plate around an axis through the pin so the attached safety device moves between a perpendicular and parallel position relative to the housing around an axis passing through the pin.

In certain embodiments, the first portion of the crankshaft is also coupled to the distal end of the piston through a connecting rod.

In various embodiments, the safety device comprises a stop sign or a crossing arm. In further embodiments, the stop sign comprises lights. In additional embodiments, a control unit is operably connected to the lights through an electrically coupled quick release connector.

In embodiments, the actuator comprises a mounted end opposite the piston affixed to the housing. In certain embodiments, the mounted end is affixed to the housing through a bearing. In additional embodiments, the piston is removably affixed to the connecting rod and the actuator pivots around the bearing when an end of the piston is free.

In particular embodiments, the first revolute joint comprises a bearing. In certain embodiments, the housing encloses the actuator, the piston, and, optionally, the connecting rod.

In various embodiments, the actuator is operably connected to a control unit through an electrically coupled quick release connector. In particular embodiments, a position sensor is configured to signal the control unit based on the position of the safety device.

In embodiments, the first revolute joint is disposed at a first position in a first plane when the distal end is in the extended position and at a second position in a second plane when the distal end is in the retracted position, wherein the first plane and second plane are disposed on opposite sides of a plane passing through the pin joint and parallel to the first plane and second plane. In particular embodiments, the actuator is pneumatic, hydraulic, or electric.

In a certain embodiment, the crankshaft comprises a rectangular plate second portion and the first portion comprises an elongated flat plate member extending away from a corner of the rectangular plate second portion, and wherein the rectangular plate second portion and elongated flat plate first portion lie within a common plane.

In at least one embodiment, the safety device also comprises lights electrically coupled to a control unit within the housing through wires having a portion thereof disposed within a channel disposed within a portion of the housing.

### BRIEF DESCRIPTION OF THE DRAWINGS

The foregoing, as well as the following Detailed Description, is better understood when read in conjunction with the appended drawings. For the purposes of illustration, there is shown in the drawings exemplary embodiments; however, the presently disclosed subject matter is not limited to the specific methods and instrumentalities disclosed.

The embodiments illustrated, described, and discussed herein are illustrative of the present invention. As these embodiments of the present invention are described with reference to illustrations, various modifications or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. Embodiments of the present invention are shown with reference to the following drawings introduced as follows:

FIG. 1 illustrates a top rear side perspective view of a safety device deployment apparatus according to one or more embodiments wherein the housing is illustrated as transparent for convenience to show the components therein;

FIG. 2 illustrates a top rear side perspective view of a safety device deployment apparatus according to one or more embodiments utilizing dashed lines to demonstrate portions of the device disposed within the housing and generally out of the line of sight from the respective viewing position;

FIG. 3 illustrates a side elevation view of a safety device deployment apparatus according to one or more embodiments utilizing dashed lines to demonstrate portions of the device disposed within the housing and generally out of the line of sight from the respective viewing position;

FIG. 4 illustrates a top plan view of a safety device deployment according to one or more embodiments wherein portions utilizing dashed lines to demonstrate portions of the device disposed within the housing and out of the line of sight from the respective viewing position;

FIG. 5 illustrates a front-end elevation view of a safety device deployment apparatus according to one or more embodiments wherein portions utilizing dashed lines to demonstrate portions of the device disposed within the housing and out of the line of sight from the respective viewing position;

FIG. 6 illustrates a top rear side perspective view of a hinge plate and actuator linkage assembly removed from the housing of a safety device deployment apparatus according to one or more embodiments;

FIG. 7 illustrates a top rear side perspective view of a hinge plate and actuator linkage assembly removed from the housing of a safety device deployment apparatus according to one or more embodiments;

FIG. 8 illustrates a side elevation view of a hinge plate and actuator linkage assembly removed from the housing of a safety device deployment apparatus according to one or more embodiments;

FIG. 9 illustrates a top plan view of a hinge plate and actuator linkage assembly removed from the housing of a safety device deployment apparatus according to one or more embodiments;

FIG. 10 illustrates a front elevation view of a hinge plate and actuator linkage assembly removed from the housing of a safety device deployment apparatus according to one or more embodiments;

FIG. 11 illustrates a series of views including a side elevation view (top left), a top plan view (bottom left), and a rear elevation view (right) of an actuator of a safety device deployment apparatus according to one or more embodiments;

FIG. 12 illustrates a side elevation diagram view of a safety device deployment apparatus according to one or more embodiments having a connecting rod disconnected from the crankshaft and having dashed lines to demonstrate motion of the connecting rod resulting from piston movement;

FIG. 13 illustrates a side elevation diagram view of a safety device deployment apparatus according to one or more embodiments having a stop sign safety device affixed to the hinge plate;

FIG. 14A illustrates a top plan diagram view of a safety device deployment apparatus according to one or more embodiments with a certain shaped housing having a cover removed to show a control unit and wiring having quick release electrical connectors;

FIG. 14B illustrates a top plan diagram view of a safety device deployment apparatus according to one or more embodiments with a certain shaped housing having a cover removed to show a control unit and wiring having quick release electrical connectors;

FIG. 14C illustrates a top plan diagram view of a safety device deployment apparatus according to one or more embodiments with a certain shaped housing having a cover removed to show a control unit and wiring having quick release electrical connectors and a position sensor;

FIG. 15 illustrates a top rear perspective view of a safety device deployment apparatus according to one or more embodiments having no cover and with a stop sign safety device in a deployed position;

FIG. 16 illustrates a top forward-facing plan view of a safety device deployment apparatus according to one or more embodiments having no cover and with a stop sign safety device in a deployed position;

FIG. 17 illustrates a bottom upward-facing plan view of a safety device deployment apparatus with a stop sign safety device in a stowed position generally parallel to the base plate of a housing according to one or more embodiments;

FIG. 18 illustrates a top rear forward-facing perspective view of a safety device deployment apparatus according to one or more embodiments having no cover and with a stop sign safety device in a deployed position;

FIG. 19 illustrates a top rear forward-facing perspective view of a safety device deployment apparatus according to one or more embodiments having no cover and with a hinge plate in a deployed position;

FIG. 20 illustrates a front-end elevation perspective view of a safety device deployment apparatus according to one or more embodiments turned on a side so that the having no front sidewall and with a hinge plate in a deployed position;

FIG. 21 illustrates a front-end elevation view picture of a safety device deployment apparatus according to one or more embodiments having no front sidewall and with a hinge plate in a stowed position;

FIG. 22A illustrates a top plan view of a base plate of the housing of a safety device deployment apparatus according to one or more embodiments;

FIG. 22B illustrates a side elevation view of a side wall of the housing of a safety device deployment apparatus according to one or more embodiments;

FIG. 23 illustrates a top plan view of the body of a hinge plate of a safety device deployment apparatus according to one or more embodiments;

FIG. 24A illustrates a side elevation view of an extension portion of a hinge plate of a safety device deployment apparatus according to one or more embodiments;

FIG. 24B illustrates a bottom plan view of a hinge plate, including attached extensions, of a safety device deployment apparatus according to one or more embodiments;

FIG. 25A illustrates a side elevation view of a crankshaft of a safety device deployment apparatus according to one or more embodiments having the first portion, that connects to the connecting rod, extending upward and away from the second portion, the edge of which contacts the hinge plate;

FIG. 25B illustrates a side elevation view of a connecting rod of a safety device deployment apparatus according to one or more embodiments having a second end which connects to the crankshaft and a first end shown separate from but which connects to a screw cap attachment for connecting in mating engagement with the distal end of a piston;

FIG. 26 illustrates a top plan view of a diagram of a safety device deployment apparatus according to one or more embodiments having a crankshaft affixed at one end directly to the piston through a revolute joint and affixed at an opposite end to the pin, to which the hinge plate is secured so motion of the piston causes rotation of the pin and pivotal movement of the hinge plate; and

FIG. 27 illustrates a side elevation view of a diagram of the safety device deployment apparatus of FIG. 26.

### DETAILED DESCRIPTION

The following description and figures are illustrative and are not to be construed as limiting. Numerous specific details are described to provide a thorough understanding of the disclosure. In certain instances, however, well-known, or conventional details are not described to avoid obscuring the description. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way.

Alternative language and synonyms may be used for any one or more of the terms discussed herein. No special significance is to be placed upon whether a term is elaborated on or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure.

### Device Generally

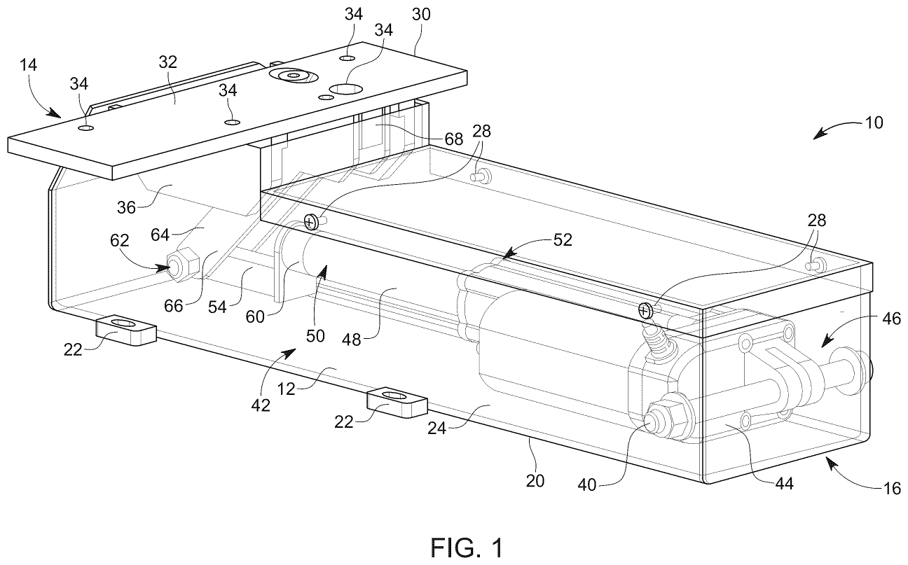

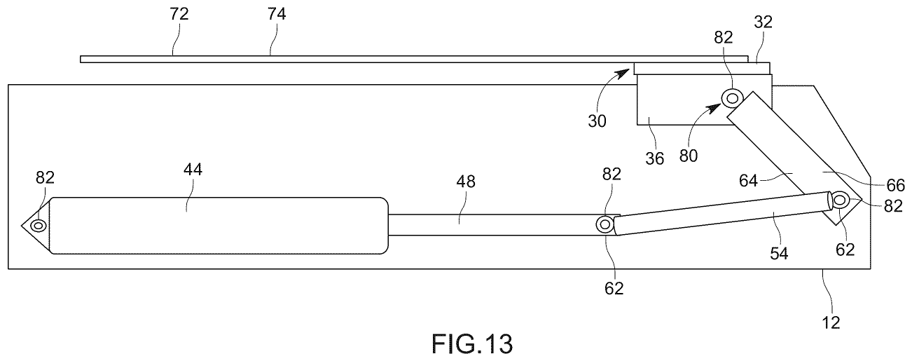

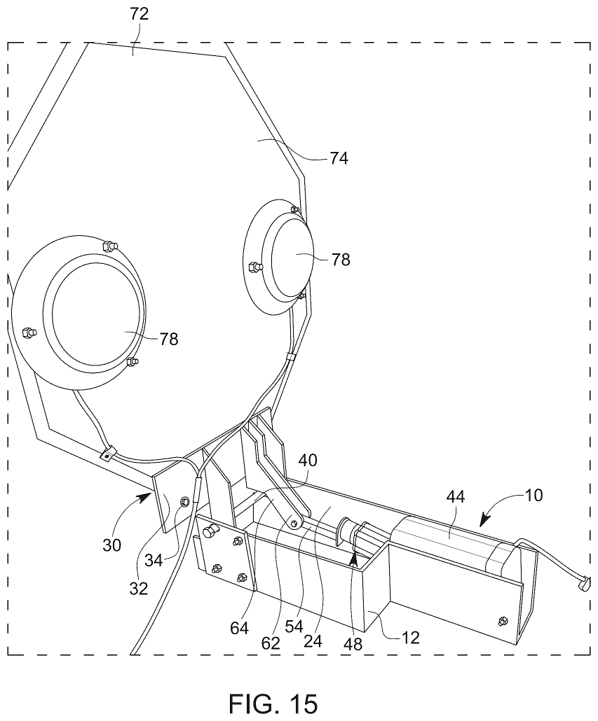

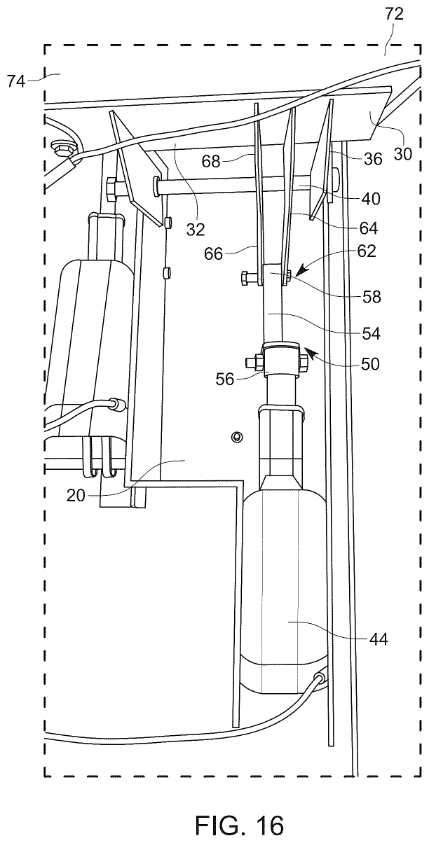

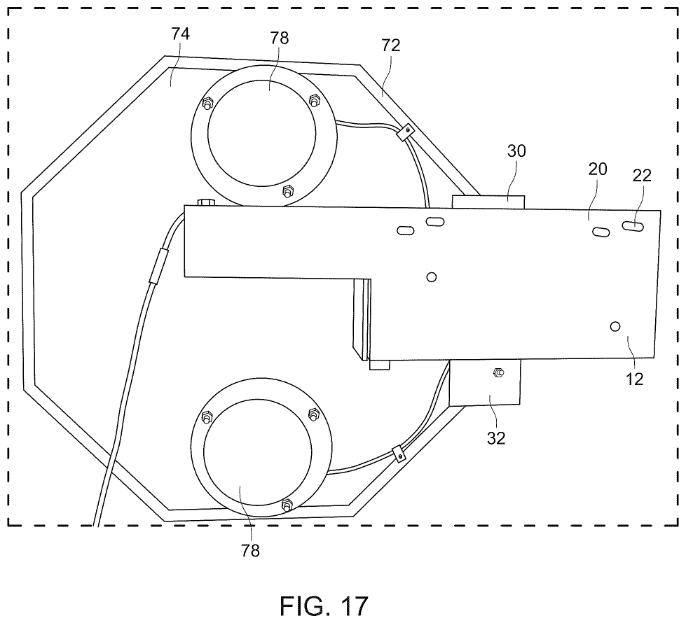

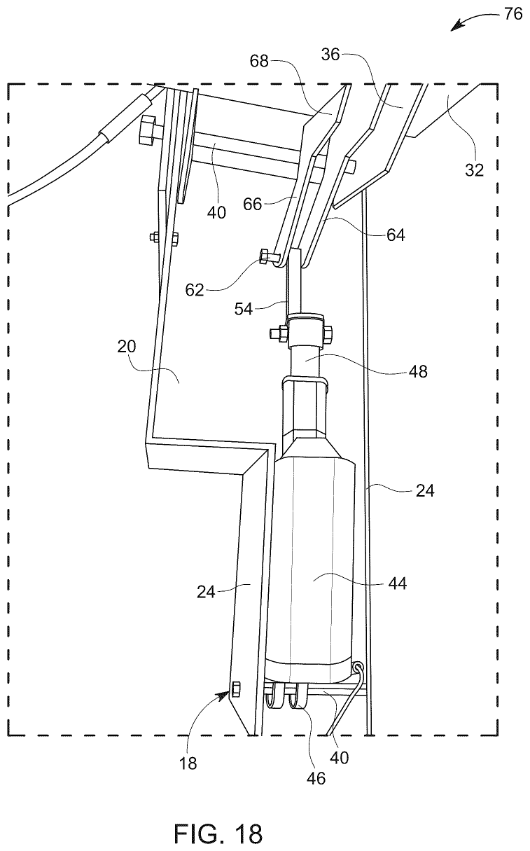

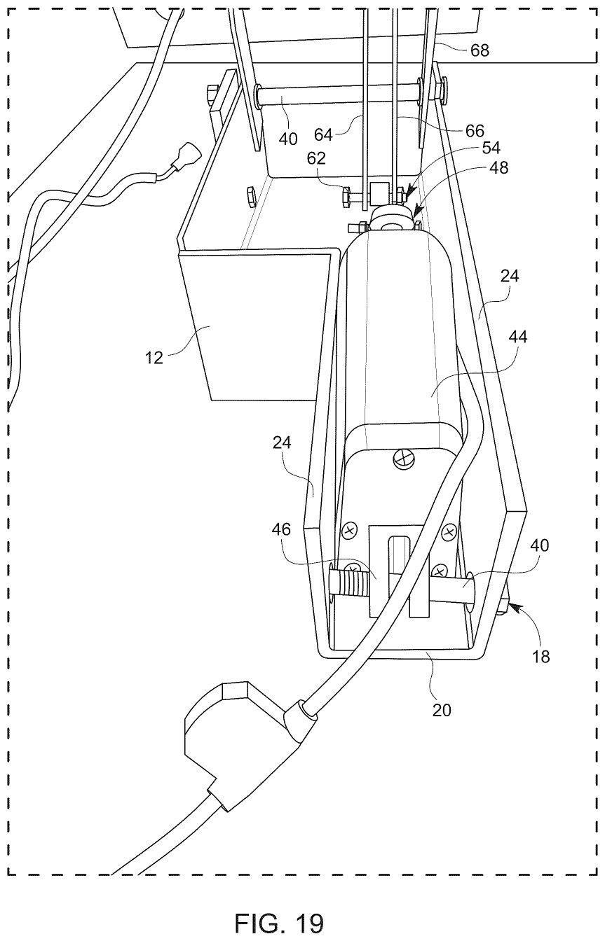

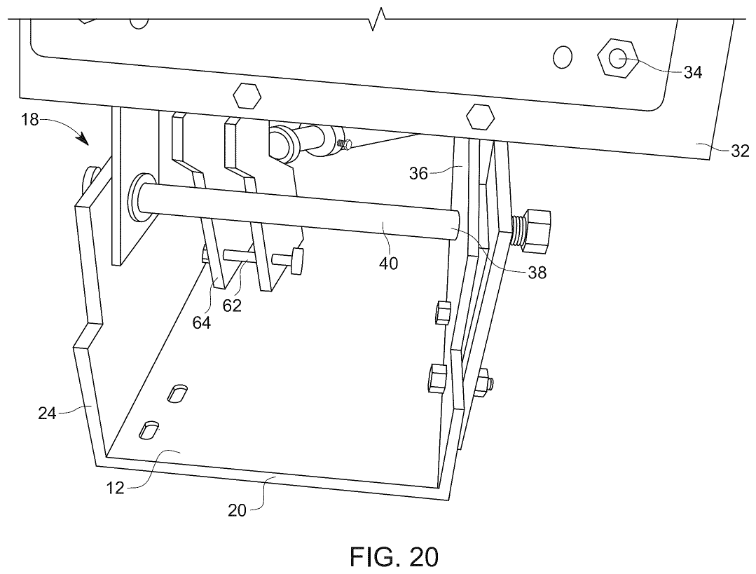

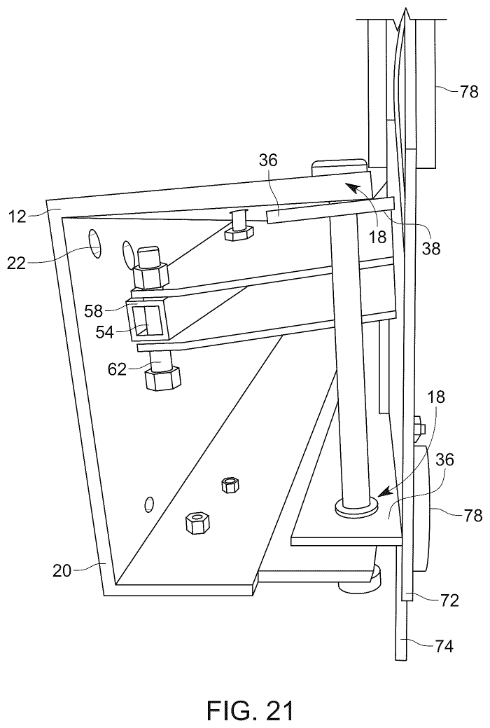

As shown in FIGS. 1, 13, 15-21 and 26-27, embodiments of a safety device deployment apparatus 10 include a housing 12, a hinge plate 30 pivotally attached to the housing 12, and an actuator linkage assembly 42, generally disposed within the housing 12 in embodiments. The actuator linkage assembly 42 generally includes an actuator 44 mounted to a portion of the housing 12 and including a linearly moveable piston 48, and a crankshaft 64 coupled, at a first end, to the piston through at least a revolute joint 62, and optionally a connecting rod 54. The crankshaft 64, of the actuator linkage assembly 42, is coupled at a second end, opposite the first end, to either the pin 40, the hinge plate 30, or the safety device 72 (see FIGS. 13 and 15) itself. In use, embodiments of the safety device deployment apparatus 10 move a safety device 72 (see FIGS. 13 and 15), mounted to the hinge plate 30, between a stowed position (FIG. 13) and a deployed position (FIG. 15).

In embodiments, the hinge plate 30, and at least the affixed portion of the safety device 72, are generally disposed parallel relative to a portion of the housing 12, such as a cover 26 or base plate 20, or a cross-sectional plane passing through the actuator 44, when in a stowed position. Moreover, the hinge plate 30, and at least the affixed portion of the safety device 72 are generally disposed perpendicular relative to those same portions of the apparatus 10 when in a deployed position. Further, the hinge plate 30 is pivotally attached to the housing 12 through a pin 40 to facilitate, and limit, motion of portions of the apparatus 10 between the stowed and deployed positions, in embodiments. In embodiments, the pin 40 provides a rotational axis for movement between the stowed and deployed positions

Movement between the stowed position and deployed position is operably controlled by the linear extension and retraction of the piston 48 of the actuator 44 in embodiments. In such embodiments, the linear motion of the piston 48 is communicated to the hinge plate 30 through mechanical linkages, such as crankshaft 64 and optional connecting rod 54. In embodiments, the transformation of linear motion in the piston 48 to rotational motion of the hinge plate 30 is influenced by the connection between a connecting rod 54 and crankshaft 64. Indeed, motion of the hinge plate 30, and any affixed safety device 72, between a stowed position and a deployed position is facilitated by the position of a revolute joint 62 connecting the connecting rod 54 and the crankshaft 64 when in each of the stowed and deployed positions in embodiments. In other embodiments, the crankshaft 64 can be affixed to the distal end of the piston 48 through a revolute joint 62, without a connecting rod 54, and connected to the pin 40, such that motion of the piston 48 causes rotational motion of the pin 40 and a connected hinge plate 30.

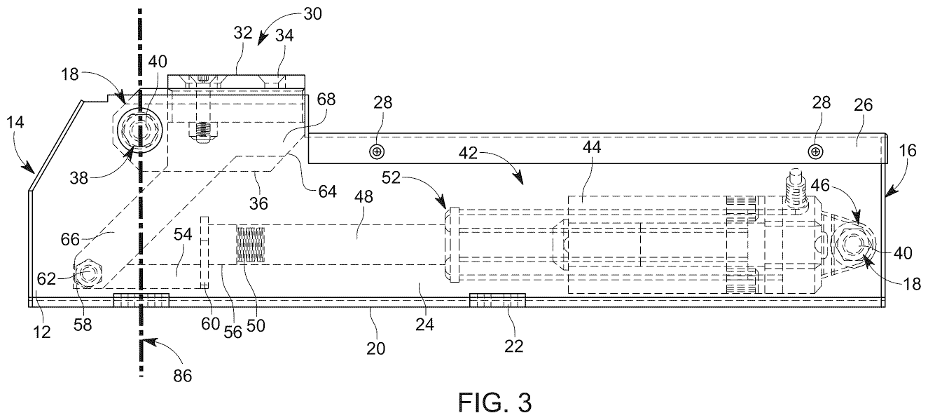

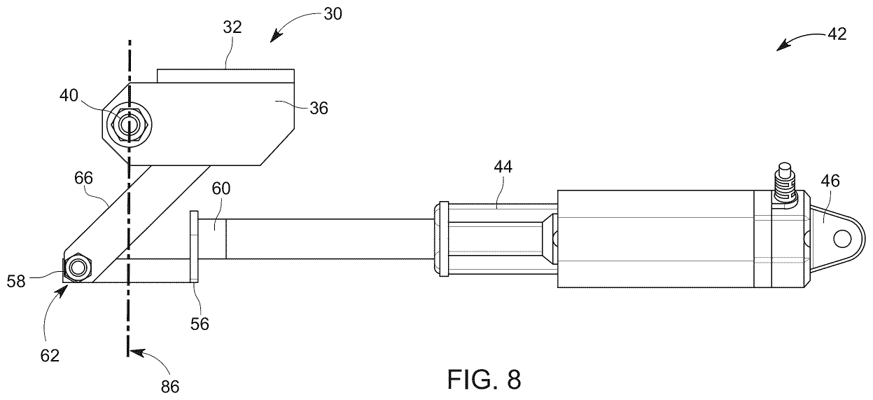

In embodiments, a revolute joint 62 can be moved between positions on opposite sides of a plane 86 (See FIG. 3 and FIG. 8) passing through the pin 40 and orthogonal to line of motion for the piston 48. Thereby, extension or retraction of the piston 48, in embodiments, moves the revolute joint 62 from one side to another side relative to the plane 86 and—through motion of the attached crankshaft 64—communicates force to pivot the hinge plate 30, and attached safety device 72, between a stowed position and deployed position around a rotational axis represented by the pin 40.

### Elements

While various features and elements have been described in reference to particular embodiments and variations above, it is to be understood that no limitation of the scope of this disclosure is hereby intended. Thereby, elements and features might be utilized in any combination and for any embodiment to which it is particularly useful. To further promote understanding of the principles of the present disclosure, additional discussion related to particular elements of the present discussion is provided below.

### Housing

As shown in FIGS. 1-5 and 12-21, the apparatus 10 generally comprises a housing 12 having a first end 14 and a second end 16. The housing 12 provides an enclosing structure for one or more of the other portions of the apparatus 10 that can be mounted to a vehicle. Thereby, the housing can help provide protection to portions of the apparatus 10 from exposure to the elements, aiding longevity, and provide a common mounting structure to easily connect portions enclosed therein to a vehicle, simplifying installation and removal of the apparatus 10.

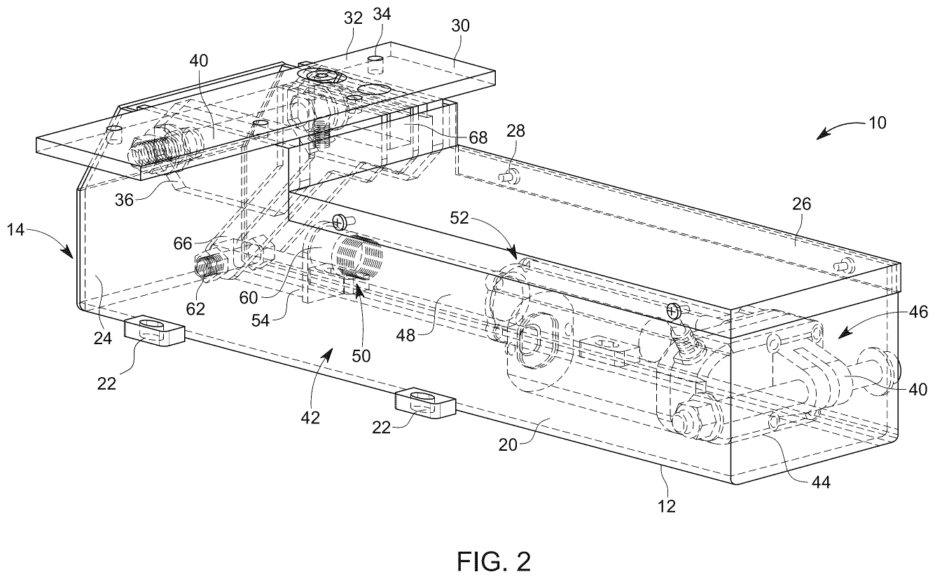

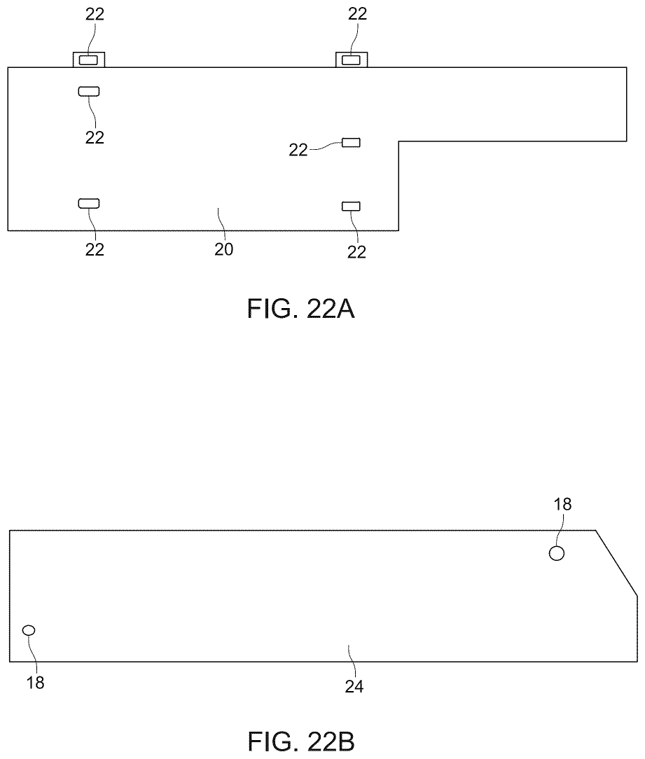

In embodiments, the housing 12 comprises a base plate 20, sidewalls 24 and a cover 26, such as in FIGS. 1 and 2. In embodiments, the housing 12, such as the sidewalls 24, has one or more apertures 18 proximate the first end 14 and/or second end 16 of the housing 12 as in FIG. 22B. In embodiments, a pin 40 is disposed through the aperture 18 in the housing 12 and through a portion of a hinge plate 30 so that pin 40 forms a rotational axis for the hinge plate 30 as in FIG. 3. Moreover, the housing 12, such as the sidewalls 24 may include one or more apertures 18 to facilitate mounting of the actuator 44 to the housing. For example, the sidewalls 24 may have matching apertures 18 through which a pin 40 passes and that also engages the mounted end 46 of the actuator 44, as in FIG. 1. Indeed, a pin 40 may be passed through portions of the actuator 44 and housing 12 so that the actuator 44 is pivotally attached relative to the housing.

In further embodiments, the housing 12 is mounted to a vehicle through the holes in the base plate 20 or one or more mounting tabs 22 extending from the base plate 20 as in FIG. 22A. The one or more mounting tabs 22 allow for access to fasteners, like screws, mounting the housing 12 without requiring the housing 12 to be opened. In embodiments, the holes and fasteners may be disposed through the base plate 20 in locations that are only accessible through the interior of the housing 12 when the housing 12 is opened to protect the fasteners from the elements. In at least one embodiment, the mounting tabs 22 may separately have covers, caps, or the like which protect the fasteners utilized therewith without necessarily requiring access to the interior of the housing 12.

In additional embodiments, the cover 26 is removably attached through one or more fastening devices 28, such as screws, to allow access to portions of the apparatus 10 within the housing 12. In at least one embodiment, one or more of the fastening devices 28 may comprise a spring biased extension, such as a button or plunger, which mates with an opening, so that the cap may be removable without the use of tools.

All or portions of the housing 12 may be shaped and sized to effectively enclose and allow portions housed therein to operate. For example, the base plate 20 of the housing 12 may be generally rectangular, as in FIGS. 1 and 2, or any other shape, such as the shape of FIG. 22A. Indeed, as shown in FIG. 3, one or more of the sidewalls 24 may have portions of differing shapes, such as the bend in the front, first end 14 of the housing 12 to accommodate motion of the hinge plate 30 and any attached safety device 72. Thereby, the housing 12 may effectively be any shape in embodiments.

Moreover, the housing 12 may include gasket materials disposed along the junction between the cover 26 and the sidewall 24 in embodiments. In further embodiments, the housing 12 may have a gasket or extending flap of material away from the base plate 20 to help prevent water or materials from entering the space between the side of a vehicle and the housing 12. Additionally, each aperture 18 opening may also include sealing elements to prevent material from unintentionally entering the housing 12. For example, the cover 26 may include a sealing extension portion that is adjustable, such as by stretching, into a position that covers the one or more openings created when the hinge plate 30 is pivoted into a deployed position. In at least one embodiment, the sidewalls 24 and cover 26 are removably affixed to a rubberized sleeve that is removably connected to the safety device 72 or the hinge plate 30 itself such that water is prevented from entering the housing 12 adjacent to the hinge plate 30.

### Hinge Plate

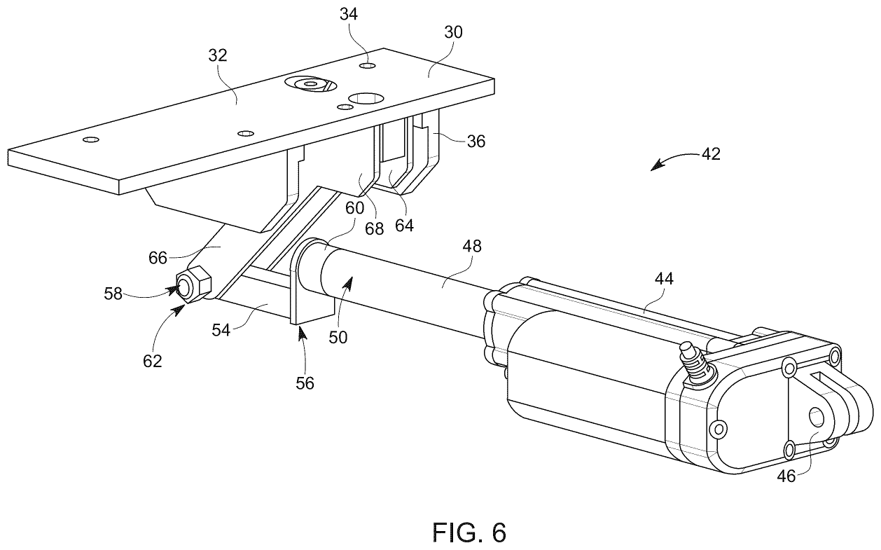

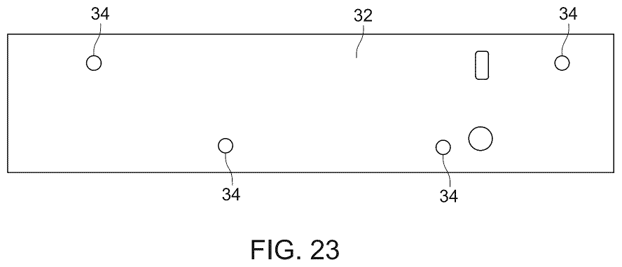

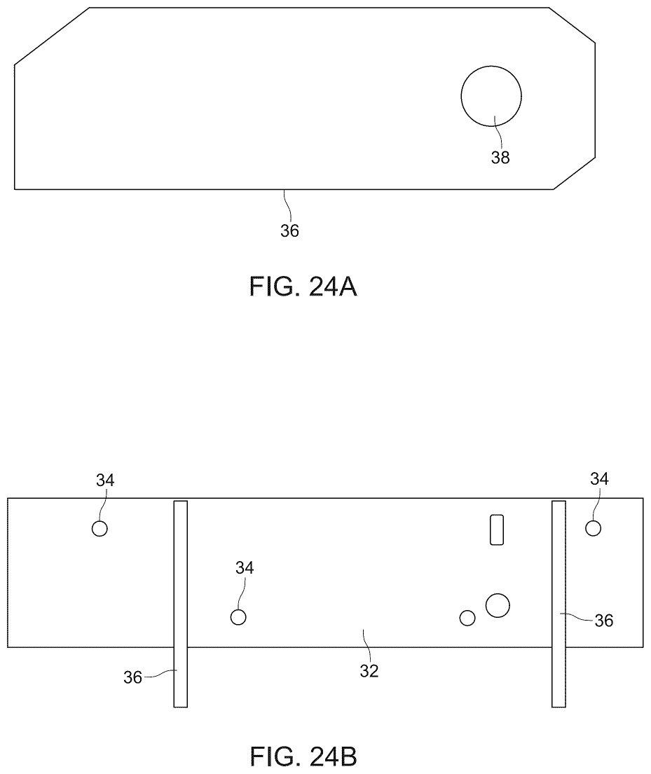

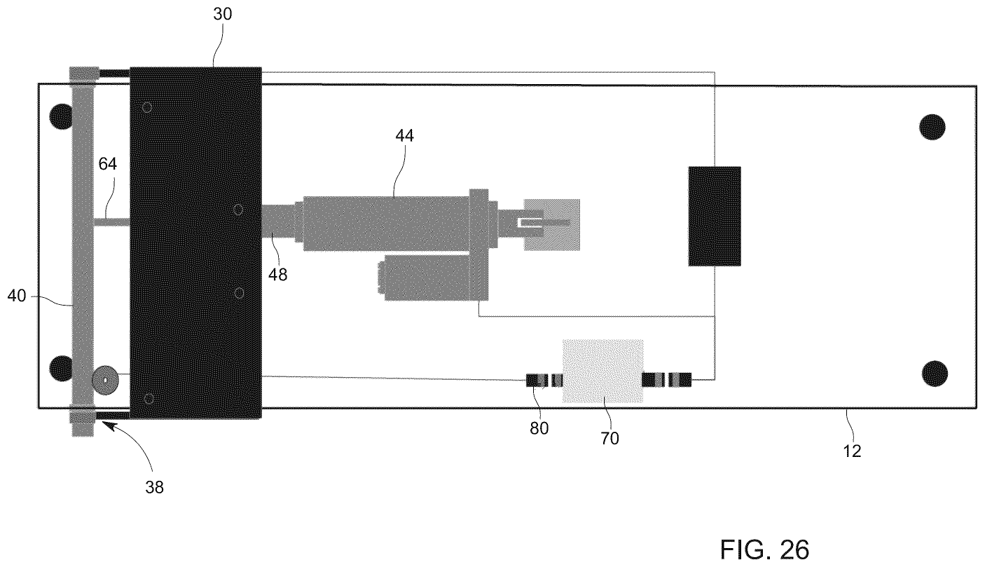

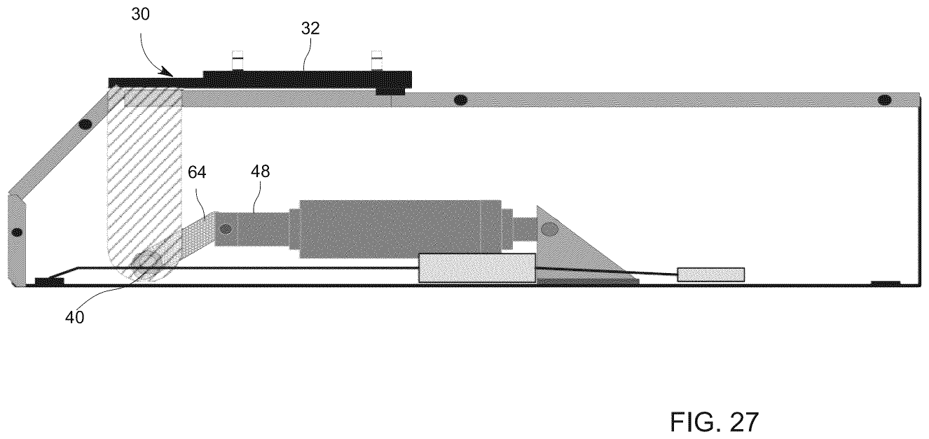

As shown in FIGS. 1-5, the apparatus 10 comprises a hinge plate 30 to which a safety device 72 may be mounted. The hinge plate 30 includes a body 32 having one or more mounting portions 34 utilized to affix the safety device 72 in embodiments, as shown in FIGS. 6 and 23. In further embodiments, the hinge plate 30 includes one or more extensions 36 protruding from the body 32 of the hinge plate 30, as in FIGS. 6 and 24B. In embodiments, the extensions 36 may be coupled to portion of the pin 40 within the housing 12. In alternative embodiments, the extensions 36 may be coupled to portions of the pin 40 outside the housing 12. The one or more extensions 36 may include an opening 38, as in FIG. 24A, through which the pin 40, discussed in reference to the housing 12, may pass and by which the hinge plate 30 may be pivotally mounted relative to the housing 12. In embodiments, the extensions 36 may pivot freely around a pin 40 based on the pin 40 passing through the opening 38. In other embodiments, extensions 36 may be attached to the pin 40 in fixed relation, such that motion of the pin 40 results in related motion of the extensions 36 and hinge plate 30, such as in FIGS. 26 and 27.

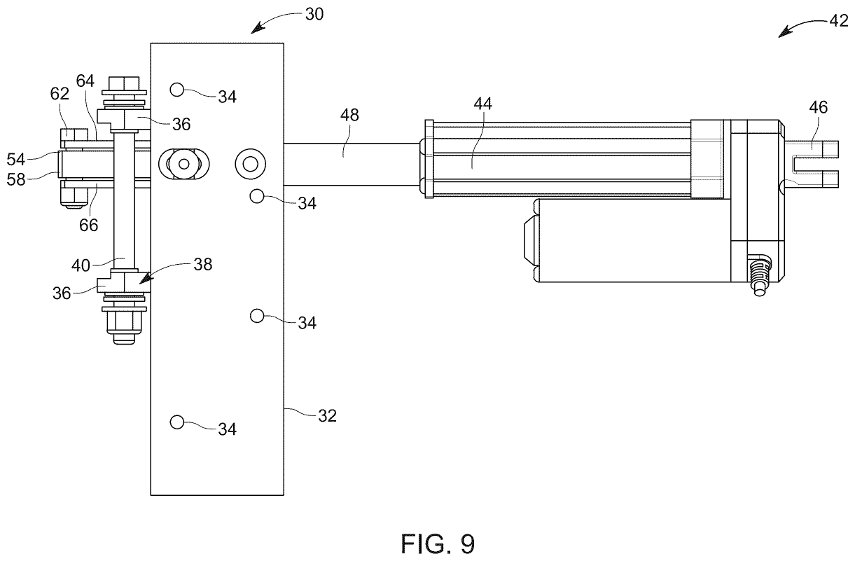

In embodiments, the one or more extensions 36 may extend away in a plane orthogonal to that of the body 32. Moreover, the one or more extensions 36 may have portions which extend beyond the periphery of the body 32 in other directions in embodiments. For example, in FIGS. 9 and 26, portions of the extensions 36, specifically those having an opening 38 for a pin 40, are disposed in a position beyond the periphery of the body 32. That is, if the peripheral edge of the body 32 defined a plane perpendicular to the body 32, a portion of each extension 36 would be disposed on an opposite side of such plane from the body 32 itself. The shape of the extensions and disposition of a portion outside the periphery, as indicated above, allows the body 32 to be disposed a distance from the rotation axis to provide clearance for an affixed safety device 72 during movement. In embodiments, the body 32 may include a customized attachment segment based on the specific safety device 72 to be attached. For example, the customized attachment segment may comprise one or more channel members disposed to accept rails, poles, posts, or other portions extending away from a particular safety device 72. The customized attachment segment may be secured to the body 32 and/or portions of the safety device 72 through attachments requiring tools, like screws, bolts, etc., and those removably attachable without tools, such as spring-loaded buttons, plungers, or tabs and mating apertures. Thereby, the customized attachment segment can provide adjustability without requiring adjustment or adaptation of the safety device 72 itself, such as drilling holes to accommodate connection with a body 32. In at least one embodiment, a customized attachment segment may comprise a clamp to secure a safety device 72.

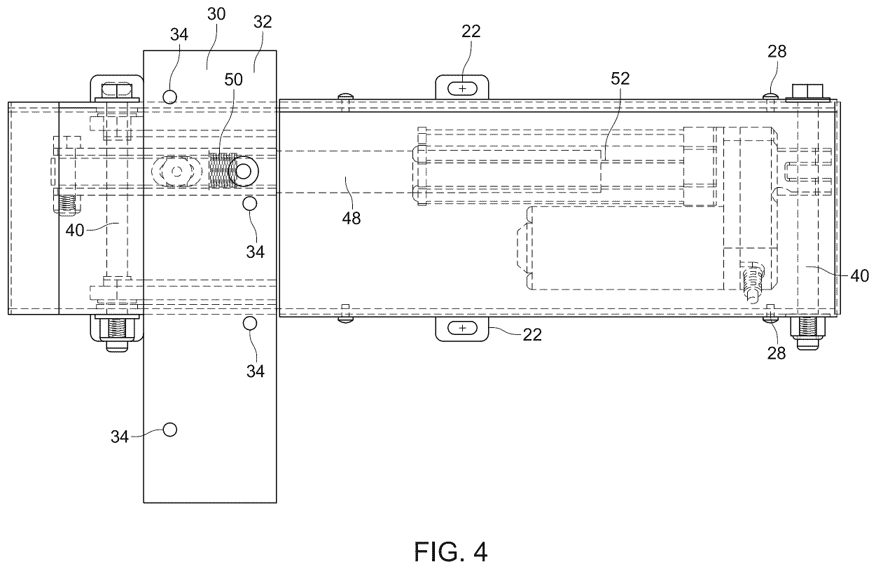

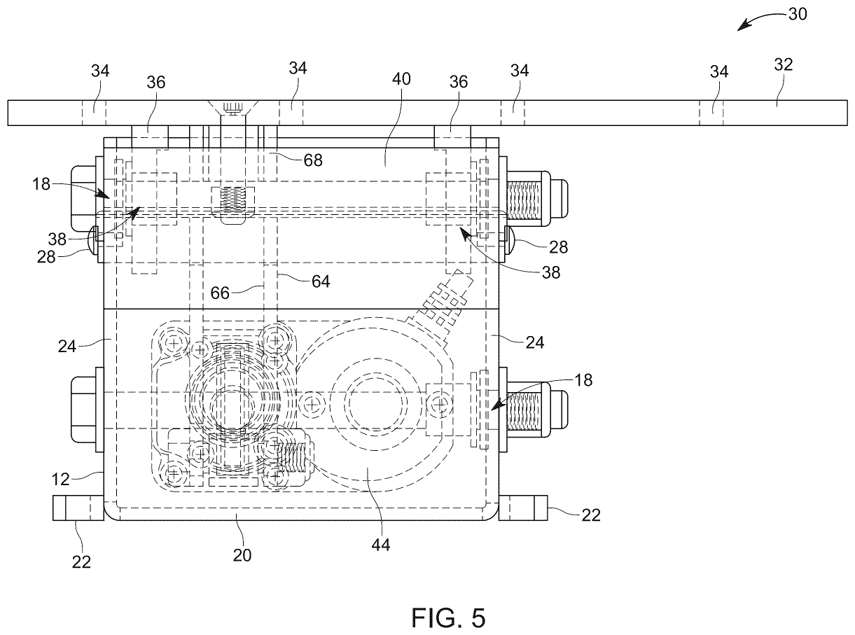

In embodiments, the hinge plate 30 may include one or more mounting portions 34, such as along the body 32, through which the safety device 72 and/or the crankshaft 64 may be attached. Indeed, in embodiments like that of FIGS. 4 and 5, the body 32 of the hinge plate 30 may include holes through which fasteners, like screws, may be passed to affix the safety device 72 and crankshaft 64. Thereby, a hinge plate 30 may be replaced with another which provides a better fit with a particular safety device 72, in embodiments. For example, a particular hinge plate 30 may be attached to the housing 12 and crankshaft 64 to affix a stop sign 74 and a different hinge plate 30 may be attached to affix a crossing arm 76. However, the crankshaft 64 may be inseparably affixed to the body 32, such as through welding, in embodiments. In such embodiments, a customized attachment segment may be utilized with the body to provide a better fit, as specified above.

### Actuator Linkage Assembly

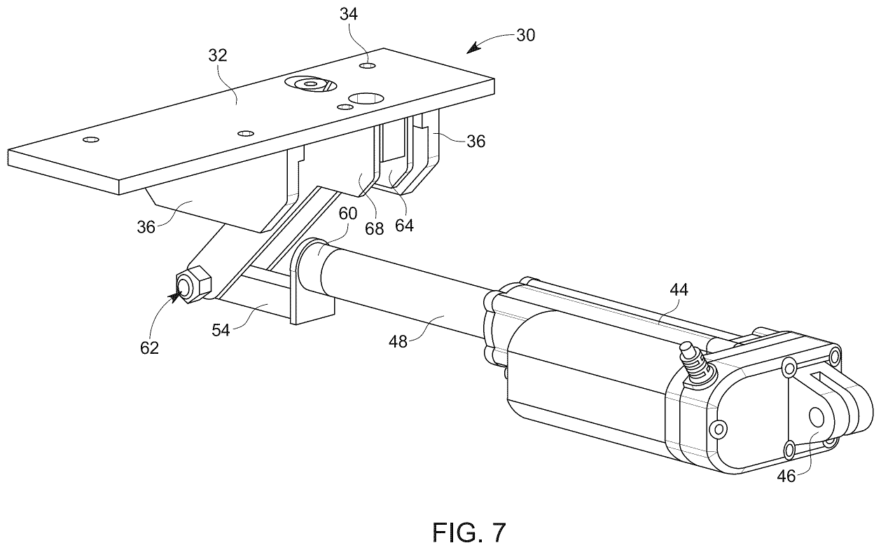

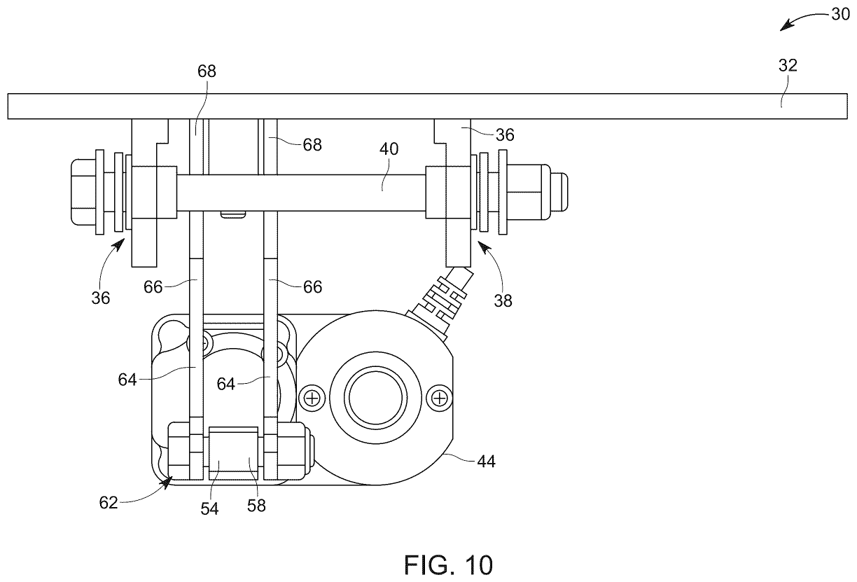

As shown in FIGS. 1-5, 15-16, and 18-19, the apparatus 10 includes an actuator linkage assembly 42 in embodiments. As shown in FIGS. 6-10 and 12-13, the actuator linkage assembly 42 comprises an actuator 44 including a linearly moveable piston 48, a connecting rod 54 attached to the piston, a crankshaft 64 attached at one end to the connecting rod 54 through a revolute joint 62 and at another end to the hinge plate 30, in embodiments. As shown in FIGS. 26 and 27, the actuator linkage assembly 42 comprises an actuator 44 including a piston 48 and a crankshaft 64 attached at one end to the piston 48, through a revolute joint 62 and at another end to the pin 40 which is attached in fixed relation to the hinge plate 32 such that motion piston 48 translates motion to the crankshaft 64 which translates motion to the pin 40 and then to the hinge plate 32.

### Actuator

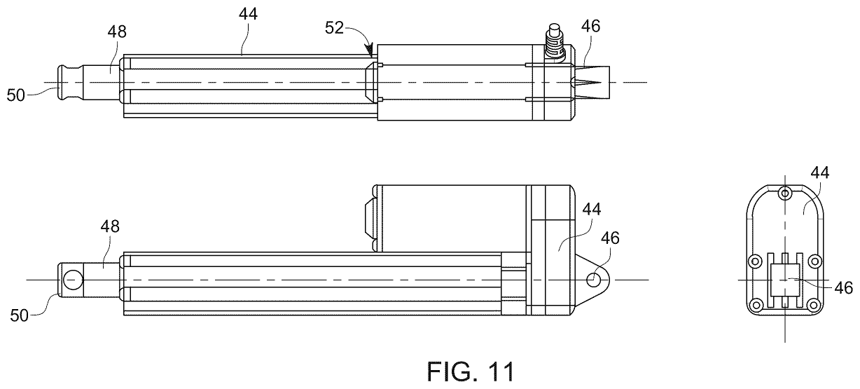

In embodiments, the actuator 44, an example of which is shown in FIG. 11, is attached to the housing 12 as in FIGS. 1-5. In further embodiments, the actuator 44 is pivotally attached to the housing 12. Indeed, in embodiments, a mounted end 46 of the actuator 44 is pivotally attached through a pin 40 passing through one or more apertures 18 in the sidewall 24 of the housing 12 and through portions of the actuator 44 as in FIGS. 1-4. Thereby, the actuator 44 can pivot towards and away from the base plate 20 when its piston 48 is unconnected. However, the actuator 44 may be pivotally attached to any portion of the housing 12 through other structures than a pin 40 in embodiments. Indeed, a bearing 82 may connect the mounted end 46 of an actuator 44 to the housing 12, as in FIG. 13, providing the ability to pivot in various embodiments. In certain embodiments, a clamp, strap, or tie may be affixed to the base plate 20 of the housing 12 and extend into the interior to surround and secure a portion of the actuator 44 in embodiments, as in FIG. 27. Thereby, lateral forces generated by the piston 48 may not inadvertently cause movement of the actuator 44. In one embodiment, a cable tie may be disposed around the actuator 44 and through a loop or slit attached to or formed into the base plate 20. Indeed, a cable tie provides an easily severable and replaceable element sufficient to secure the actuator in embodiments. Moreover, the actuator 44 may be removably attached to portions of the housing 12 to facilitate its replacement. Indeed, in embodiments, removal of the pin 40 securing the mounted end 46 can at least partially release the actuator from the housing 12.

Further, the actuator 44 includes a linearly moveable piston 48 in embodiments as in FIGS. 1, 11, and 16, for example. The piston 48 has a distal end 50 and a proximal end 52, in embodiments, with the proximal end 52 disposed within the actuator 44 and the distal end 50 disposed furthest away from the actuator 44. In embodiments, a connecting rod 54 is removably affixed directly to or adjacent a distal end 50 of the piston 48. In embodiments, the distal end 50 of the piston 48 can have an opening or threads to accommodate connection with a connecting rod 54 or a crankshaft 64. For example, a distal end 50 of the piston 48 can have an opening sized and shaped to allow insertion of the connecting rod 54 and the connecting rod 54 can have a channel therethrough that aligns with holes through the periphery of the distal end 50 so that a locking pin can be inserted therethrough and secure the connecting rod 54 and piston 48. In at least one embodiment, the distal end 50 and the connecting rod 54 or crankshaft 64 may be affixed together through a flexible connector which facilitates limited bending motion between the piston 48 and the connecting rod 54 or the crankshaft 64. Thereby, the flexible connector can prevent unnecessary stress damage to the connecting rod 54, crankshaft 64, and other joints and mechanical linkages. In still another embodiment, a distal end 50 and connecting rod 54 may utilize a version of a revolute joint 62 to accommodate limited bending motion in a similar manner to a separate flexible connector, as in the embodiment of FIGS. 13 and 27.

In embodiments, the actuator 44 can be electric, pneumatic, or hydraulic in nature. Moreover, the actuator 44 may be chosen to be a rating, shape, and size to allow for effective movement of the safety device 72. However, beneficially, the mechanical linkages of the embodiments of apparatus 10 herein can allow for a smaller actuator 44 to be utilized.

### Connecting Rod

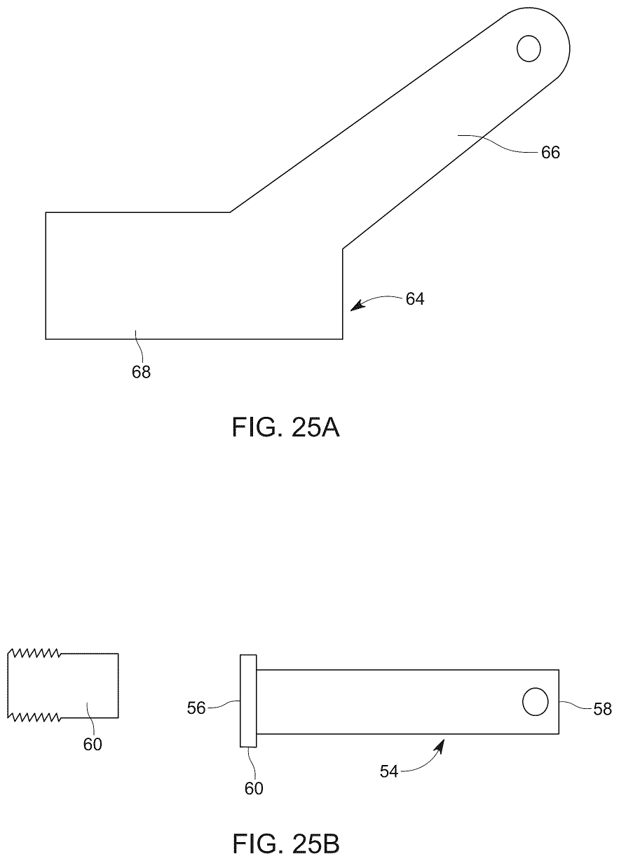

In embodiments, a connecting rod 54 connects the piston 48 to the crankshaft 64, as in FIGS. 6-10 and 13. In at least one embodiment, the connecting rod 54 has a first end 56 affixed to the distal end 50 of a piston 48. In a further embodiment, the first end 56 of the connecting rod 54 has a screw cap attachment 60 end that mates with a threaded distal end 50 of the piston 48 as shown in FIGS. 2 and 25B. However, the connecting rod 54 and piston 48 may be affixed together through any other removable means in embodiments. The ability to disconnect the connecting rod 54 and piston 48 facilitates the replacement of one or more of the connecting rod 54 and the actuator 44 in embodiments. Moreover, the ability to disconnect the connecting rod 54 and piston 48 also facilitates the ability of the actuator 44 to pivot as discussed in embodiments previously.

In embodiments, the connection between the connecting rod 54 and the piston 48, such as the screw cap attachment 60 can provide an offset to facilitate the correct alignment of portions of the apparatus 10 to promote effective operation, such as shown in FIG. 8. Indeed, in the embodiment of FIG. 8, planes passing through the center of the piston 48 between the proximal end 52 and distal end 50 and through the connecting rod 54 between an opposed first end 56 and second end 58 are parallel and offset by a distance. Indeed, the offset distance can help ensure the correct alignment of a revolute joint 62 connecting the second end 58 of the connecting rod 54 to the crankshaft 64, particularly relative to the pivot point of the hinge plate 30, such as pin 40. Thereby, a particular offset can help reduce sheer stresses in the connection between the connecting rod 54 and the crankshaft 64 while facilitating operating of the apparatus 10 in a variety of dimension and allowing for the apparatus to be more compact in various dimensions.

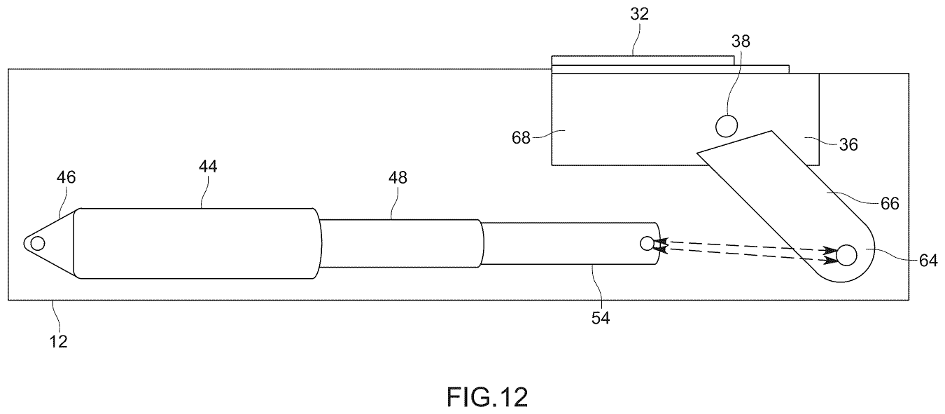

In at least one embodiment, the connection between the connecting rod 54 and the piston 48 can be through a revolute joint 62, such as a bearing 82 as in FIG. 13. Thereby, the distal end 50 of the piston 48 may be pivotally attached to the first end 56 of the connecting rod 54 to reduce stress on the connection during operation. In embodiments, the revolute joint 62 may have constraints to limit the range of motion to ensure proper motion of portions of the apparatus 10. In such embodiments, the revolute joint 62 between the distal end 50 and the piston 48 may obviate the need for an offset, as earlier mentioned embodiments. In all embodiments, movement of the piston 48 generates some movement, in the linear direction of the piston 48, in the connecting rod 54 which is translated into the crankshaft 64 and ultimately into the hinge plate 30. Indeed, FIG. 12 has dashed lines to demonstrate lateral motion of one embodiment of a connecting rod 54 during operation of the piston 48.

The connecting rod 54 further comprises, in embodiments, a second end 58 pivotally affixed to a portion of the crankshaft 64, such as the finger-like extending first portion 66 through a revolute joint 62, such as a bearing 82. Thereby, the angle between the second portion 68 of the crankshaft 64 and the connecting rod 54 may change during operation of the actuator 44, generating a motion in the first portion 66 of the crankshaft 64 that pivots the hinge plate 30. In at least one embodiment, the connecting rod 54 may further comprise an additional element pivotally affixed between the connecting rod and crankshaft.

In at least one embodiment, the distal end 50 of the piston 48 may be directly affixed to a portion of the crankshaft 64, such as the first portion 66, through a revolute joint 62, removing any intervening linkages, such as the connecting rod 54, as in FIGS. 26 and 27. This design has the benefit of simplicity regarding moving parts and functionality. However, the actuator 44 may need to be free to pivot relative to the housing 12 and the shape of the crankshaft 64 may need to be customized to enhance performance. Indeed, the crankshaft 64 may be a flat elongated member connected at one end to a piston 48, through a revolute joint 62, and at another end to the pin 40, as in FIGS. 26 and 27.

### Crankshaft

In embodiments, the apparatus 10 comprises a crankshaft 64 having a second portion 68 and a first portion 66 extending away from the second portion, as in FIG. 25A. In embodiments, the crankshaft 64 is attached to a connecting rod 54 along a first portion 66 through a revolute joint 62, as described previously, and attached along a second portion 68 to a hinge plate 30, as shown in FIG. 8. In embodiments, the second portion 68 is affixed to the body 32 of the hinge plate 30. Indeed, in some embodiments, the hinge plate 30 includes mounting portions 34 that allow the crankshaft 64 and hinge plate 30 to be removably affixed. In fact, the second portion 68 of the crankshaft 64 may comprise a threaded opening or channel to accept a threaded male fastener, like a screw, used to removably affix the hinge plate 30 and the crankshaft 64 in at least one embodiment, as shown in FIG. 5. In other embodiments, the second portion 68 of the crankshaft 64 may be inseparably affixed to the body 32, such as through welding, in embodiments.

Due to the connection between the crankshaft 64 and the hinge plate 30 and the revolute joint 62, between the crankshaft 64 and the connecting rod 54, movement of the piston 48 generates a pivoting motion of the second portion 68 of the crankshaft 64 which is translated to the portion of the hinge plate 30 affixed thereto. Thereby, operation of the actuator 44 generates an extension or retraction motion in the piston 48 and movement in the connecting rod 54 and crankshaft 64 that pivots the hinge plate 30 and any attached safety device 72 around the pin 40, in embodiments.

The crankshaft 64 may be shaped to facilitate connections between portions of the apparatus 10 that provide desirable alignment during operation, in embodiments. Indeed, the shape of the crankshaft 64 may facilitate a stowed position for the hinge plate 30, and any attached safety device 72, and a deployed position based on positioning of the piston 48 of the actuator 44. For example, in an embodiment, the crankshaft 64 may have a generally rectangular second portion 68, an edge of which contacts the body 32 of the hinge plate 30, and an angularly extending finger like first portion 66, that connects to the connecting rod 54, as shown in FIG. 25A. Thereby, the crankshaft 64 is shaped to avoid interactions with the pin 40 during movement in embodiments.

In certain embodiments, the crankshaft 64 may be a long flat member, as in FIGS. 26 and 27, connected at one end to a piston and, at another end, to the pin 40. Due to the connection between the crankshaft 64 and pin 40 and the revolute joint 62, between the crankshaft 64 and the piston 48, movement of the piston 48 generates movement of the crankshaft 64 which rotates the pin 40 and the connected hinge plate 30 affixed thereto. Thereby, operation of the actuator 44 generates an extension or retraction motion in the piston 48 and movement in the crankshaft 64 that pivots the pin 40 and hinge plate 30 and any attached safety device 72 around the pin 40, in embodiments.

### Safety Device

In embodiments, the apparatus 10 comprises a safety device 72 which is deployable to communicate with those around the vehicle to which the apparatus 10 is mounted. In embodiments, this safety device 72 is a stop sign 74, such as those employed on school buses, to notify traffic around the vehicle of their lawful requirement to stop. In further embodiments, this safety device 72 is a crossing arm 76, such as those which extend from the front portion of buses to encourage pedestrians to stay out of a blind spot on a bus. In embodiments, the safety device may also include one or more lights 78 to further bring attention to these safety devices, particularly when deployed. Indeed, in one embodiment, the sign can have electroluminescent elements which light up portions of the safety device 72 when electrified. The safety device 72 may, in embodiments, include various other components such as sirens, sensors, and cameras. In embodiments where the safety device 72 includes devices which require power, the apparatus 10 may include a wiring harness or channel having one or more flexible portions so that power, data, and signal wires may be routed to any components. The harness or channel may further include one or more quick release electrical connectors to facilitate the ability to easily connect and disconnect such in embodiments. However, in embodiments, components of the safety device 72 may also be in wireless communication with control devices, such as a control unit 70.

In various embodiments, the safety device 72 can include internal channels for the routing of necessary wiring to components thereof and the channels can have a common access port near the portion of the safety device 72 to be directly or indirectly connected to the hinge plate 30. In embodiments, a quick release electrical connector may be disposed adjacent to such portion to facilitate a plug-and-play connection with any required wiring through the housing 12. In embodiments, the housing 12 can include one or more wiring tubes or channels which provide a path and protection for wires passing therethrough between power and control components, such as a control unit 70, and a location where the wires will ultimately connect with those of the safety device. In embodiments, the wiring tubes or channels can form part of a wiring harness and can be disposed within the housing 12 to be protected therein. In certain embodiments, a portion of the wiring can be disposed through the hinge plate 30. The utilization of quick release electrical connectors facilitates quick and easy repair and replacement of components.

In certain embodiments, the safety device 72 can be removed and replaced with the same or a different safety device 72, facilitating versatility in the design thereof. Thereby, a defective safety device 72 can be replaced with another functional safety device 72. In at least one embodiment, the body 32 of the hinge plate 30 can have a U-shape defining a channel between the arms thereof into which and edge of the safety device 72 may be inserted and secured. In at least one embodiment the base of the U-shaped body 32 can have in integrated electrical connector that can mate with an electrical connector along an edge of the safety device 72 to facilitate a connector that connects and operably communicates with all components of the safety device 72. CONTROL UNIT

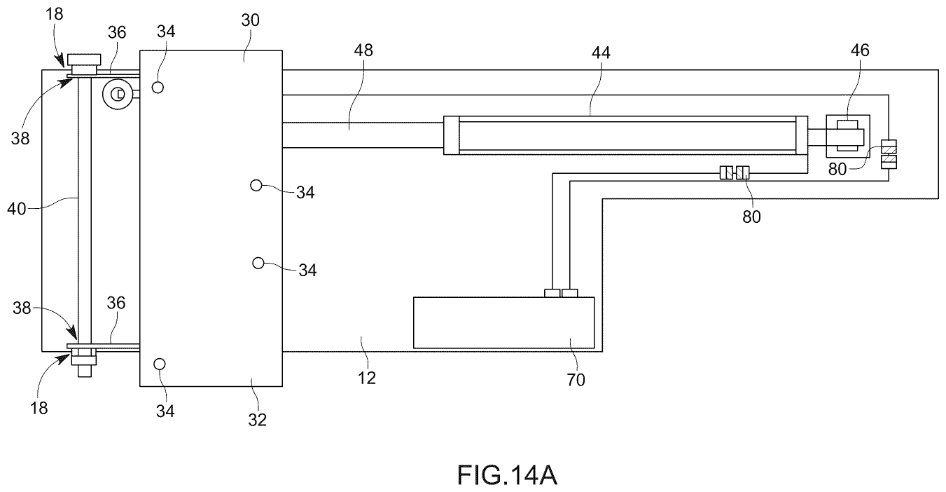

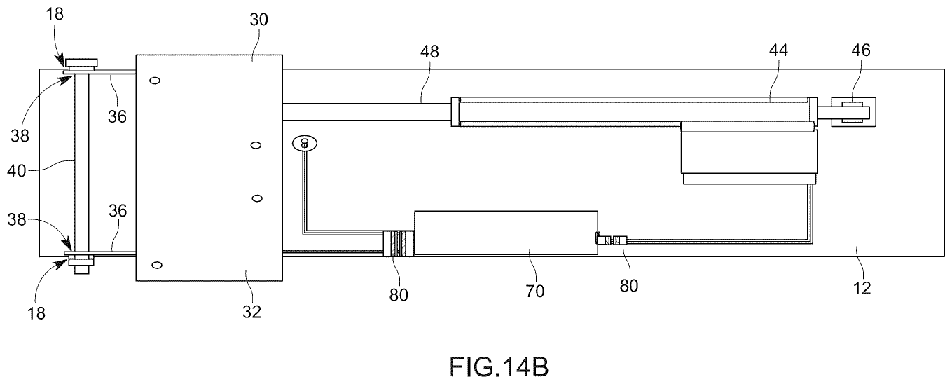

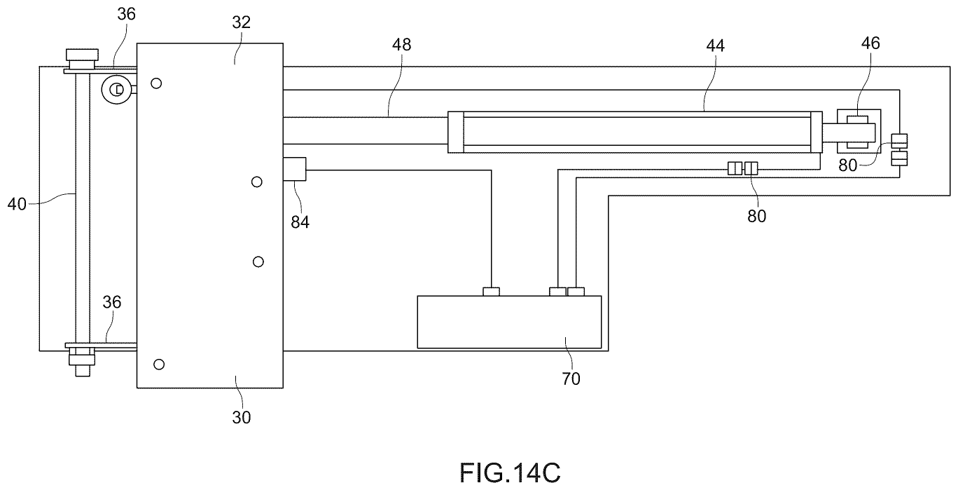

In embodiments, the apparatus 10 may also include a control unit 70 that is operationally connected with various portions, such as the actuator 44 and components of the safety device 72, such as lights 78, as in FIGS. 14A-14C. Indeed, the control unit 70 may comprise or be in communication with a switch located within the cab of a vehicle to which the apparatus 10 is mounted in embodiments. For example, the switch might be connected to the control unit 70 by being connected to an opposite end of one or more wires from the control unit, as in FIGS. 14A and 14B. In further embodiments, the control unit 70 may also include circuitry to automatically operate portions of the apparatus 10, like the actuator 44. Indeed, the apparatus 10 may include one or more sensors which assists the control unit 70 in automatically operating. For example, the apparatus 10 may include a position sensor 84 to indicate whether the hinge plate 30 and/or the safety device 72 is in a stowed or deployed position, as in FIG. 14C.

In further embodiments, the apparatus 10 also includes a heating element disposed in thermal communication with the actuator 44 and operably linked to a control unit 70 and a temperature sensor in communication with the control unit 70, where the control unit is configured to operate the heating element in response to the signal from the temperature sensor. For example, the heating element may be operated when the temperature sensor signals a temperature below a set threshold, such as −5 degrees Fahrenheit. The heating element might be any type, shape, and structure known in the art. However, in at least one embodiment, the heating element might be a flexible sheet to allow for use in a confined area, such as within elements of the present apparatus 10.

In certain embodiments, the control unit 70 may be disposed within the housing 12. Indeed, in certain embodiments, the control unit may be affixed to an actuator 44. In embodiments, the control unit 70 may be removably affixed within the housing 12. Indeed, in embodiments, wiring between the control unit 70 and various portions of the apparatus 10 may include one or more quick release electrical connectors 80 to facilitate the easy and removable attachment of the control unit 70 as in FIGS. 14A-14C.

In embodiments, the control unit includes memory that may store instructions which control operation of various portions of the apparatus 10. In further embodiments, the instructions on the memory may be adjustable through communication a port in wired communication with the control unit 70. For example, the port may be disposed within a vehicle, similar to the switch, and may be utilized to amend instructions stored in the memory. Thereby, in embodiments, operation of the apparatus 10 by the control unit can be amended as necessary.

While various features and elements have been described in general above, it is to be understood that no limitation of the scope of this disclosure is hereby intended. Thereby, elements and features might be utilized in any combination and for any embodiment to which it is particularly useful.

Any dimensions expressed or implied in the drawings and these descriptions are provided for exemplary purposes. Thus, not all embodiments within the scope of the drawings and these descriptions are made according to such exemplary dimensions. The drawings are not necessarily made to scale. Thus, not all embodiments within the scope of the drawings and these descriptions are made according to the apparent scale of the drawings regarding relative dimensions in the drawings. However, for each drawing, at least one embodiment is made according to the apparent relative scale of the drawing.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present inventive subject matter. As used herein, the term “and/or” includes all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that when an element or layer is referred to as being “on” another element or layer, the element or layer can be directly on another element or layer, or intervening elements or layers may also be present. In contrast, when an element is referred to as being “directly on” another element or layer, there are no intervening elements or layers present. As used herein, the term “and/or” includes all combinations of one or more of the associated listed items.

Spatially relative terms, such as “below,” “beneath,” “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. Throughout the specification, like reference numerals in the drawings denote like elements.

Embodiments of the inventive subject matter are described herein with reference to plan and perspective illustrations that are schematic illustrations of idealized embodiments of the inventive subject matter. As such, variations from the shapes of the illustrations as a result, for example, of manufacturing techniques and/or tolerances, are to be expected. Thus, the inventive subject matter should not be construed as limited to the shapes of objects illustrated herein, but should include deviations in shapes that result, for example, from manufacturing. Thus, the objects illustrated in the figures are schematic in nature and their shapes are not intended to illustrate the actual shape of a region of a device and are not intended to limit the scope of the inventive subject matter.

The terminology used herein is for the purpose of describing embodiments only and is not intended to be limiting of the present inventive subject matter. As used herein, the singular forms “a,” “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present inventive subject matter belongs. It will be further understood that terms used herein should be interpreted as having a meaning that is consistent with their meaning in the context of this specification and the relevant art and will not be interpreted in an idealized or overly formal sense unless expressly so defined herein. The term “plurality” is used herein to refer to two or more of the referenced items. Although any methods, devices, and materials similar or equivalent to those described herein can be used in the practice or testing of the presently disclosed subject matter, representative methods, devices, and materials are now described.

In the drawings and specification, there have been disclosed typical preferred embodiments of the inventive subject matter and, although specific terms are employed, they are used in a generic and descriptive sense only and not for purposes of limitation, the scope of the inventive subject matter being set forth in the following claims.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the forms herein disclosed. Many modifications and variations will be apparent to those of ordinary skill in the art without departing from the scope and spirit of the disclosure. The embodiment was chosen and described to best explain the principles of the disclosure and the practical application, and to enable others of ordinary skill in the art to understand the disclosure for various embodiments with various modifications as are suited to the particular use contemplated.

1. A safety device deployment apparatus comprising:
a housing defining an aperture;
a hinge plate affixed to a safety device, wherein the hinge plate is pivotally connected to the housing through a connection with a pin extending through the aperture;
an actuator linkage assembly comprising:
an actuator attached to a portion of the housing and configured to move a piston linearly between a retracted position and extended position, wherein a distal end of the piston in the extended position is disposed further away from a central portion of the actuator than in the retracted position,
a crankshaft having a first portion coupled, through at least a first revolute joint, to the distal end of the piston and a second portion affixed to one of the pin, the hinge plate, and the safety device; and
wherein movement of the distal end of the piston between the extended and retracted position generates pivotal movement of the hinge plate around an axis passing through the pin between a deployed position, wherein the hinge plate is disposed perpendicular to an axis passing through the actuator, and a stowed position, wherein the hinge plate is disposed parallel to an axis passing through the actuator.

2. The safety device deployment apparatus of claim 1, wherein the first portion of the crankshaft is also coupled to the distal end of the piston through a connecting rod.

3. The safety device deployment apparatus of claim 1, wherein the safety device comprises a stop sign.

4. The safety device deployment apparatus of claim 3, wherein the stop sign comprises lights.

5. The safety device deployment apparatus of claim 4, further comprising a control unit operably connected to the lights of the stop sign through a quick release electrical connector electrically coupled between the lights and the control unit.

6. The safety device deployment apparatus of claim 1, wherein the safety device comprises a crossing arm.

7. The safety device deployment apparatus of claim 1, wherein the actuator comprises a mounted end opposite the distal end of the piston, wherein the mounted end is affixed to the housing.

8. The safety device deployment apparatus of claim 7, wherein the mounted end is pivotally affixed to the housing through a bearing.

9. The safety device deployment apparatus of claim 8, wherein the distal end of the piston is removably affixed to the connecting rod and the actuator is pivotable around the bearing when the distal end is free.

10. The safety device deployment apparatus of claim 1, wherein the first revolute joint comprises a bearing.

11. The safety device deployment apparatus of claim 1, wherein the housing encloses at least the actuator, and piston.

12. The safety device deployment apparatus of claim 1, further comprising a control unit operably connected to the actuator through a quick release electrical connector electrically coupled between the actuator and the control unit.

13. The safety device deployment apparatus of claim 12, further comprising a position sensor configured to provide a signal to the control unit related to the position of the safety device.

14. The safety device deployment apparatus of claim 1, wherein the first revolute joint is disposed at a first position in a first plane when the distal end is disposed in the extended position and at a second position in a second plane when the distal end is disposed in the retracted position, wherein the first plane and second plane are disposed on opposite sides of a third plane passing through the pin joint, the third plane disposed between the first plane and second plane.

15. The safety device deployment apparatus of claim 1, wherein the actuator is one of pneumatic, hydraulic, and electric.

16. The safety device deployment apparatus of claim 1, wherein the crankshaft comprises a rectangular plate second portion and the first portion comprises an elongated flat plate member extending away from a corner of the rectangular plate second portion, and wherein the rectangular plate second portion and elongated flat plate first portion lie within a common plane.

17. The safety device deployment apparatus of claim 1, wherein the safety device comprises lights electrically coupled to a control unit, disposed within the housing, through wires, wherein at least a portion of the wires are disposed through a channel disposed within a portion of the housing.
